(19) United States
(12) Patent Application Publication
(10) Pub. No.: US 2020/0087185 A1
(43) Pub. Date: Mar. 19, 2020

(54) Waste water filtering garbage drying apparatus

(71) Applicant: Guozhong Wang, Guangzhou City (CN)

(72) Inventor: Guozhong Wang, Guangzhou City (CN)

(21) Appl. No.: 16/691,568

(22) Filed: Nov. 21, 2019

(30) Foreign Application Priority Data
Aug. 9, 2019 (CN) 20191027337447

(51) Int. Cl. C02F 11/13; C02F 11/123; C02F 11/126

(52) U.S. Cl. CPC C02F 11/13; C02F 2201/005; C02F 11/126; C02F 11/123

(57) ABSTRACT

The invention discloses a waste water filtering garbage drying apparatus, comprising a main body, a feeding inlet is fixed on an upper end surface of the main body, and a drying device is arranged on a lower side of the feeding opening, and the drying device can be used by the drying device The garbage entering the feed inlet is subjected to the first step of dry dewatering, and the lower side of the drying device is provided with a gate device. The present invention adopts a multi-stage drying method, and firstly dehydrates the garbage to remove a large amount of water, and then In the purpose of drying the remaining moisture by heating and taking away the moisture through the air flow, the overall footprint of the device is small, no large number of people are involved, the drying speed is fast, the drying effect is good, the working efficiency is improved, and the weather is not affected by the rainy weather. Can work at any time.

### CROSS-REFERENCES TO RELATED APPLICATIONS

The present application claims priority from Chinese application No. 2019107337447 filed on Aug. 9, 2019 which is hereby incorporated by reference in its entirety.

### TECHNICAL FIELD

The present invention relates to the technical field of garbage drying, in particular to a waste water filtering garbage drying apparatus.

### BACKGROUND OF THE INVENTION

With the progress of society, the population continues to grow, and the output of garbage is increasing day by day. For the garbage existing in rivers and waste water, it needs to be air-dried after salvage, and most of the water is discharged and then classified again. The traditional garbage drying is mainly The method of drying is adopted, the drying cycle is long and a large number of people frequently turn over, and the work efficiency is low. At the same time, the garbage drying needs to occupy a large land area, waste land resources, and the odor is generated during the drying process of the garbage, which affects environmental sanitation.

### BRIEF SUMMARY OF THE INVENTION

Technical problem: the traditional method of manure treatment is only to discard or dry, which is inefficient, high in cost and poor in drying effect.

In order to solve the above problems, the present invention designs a waste water filtering garbage drying device, which is a waste water filtering garbage drying device of the present embodiment, comprising a main body, and a feeding port is fixed on the upper end surface of the main body, the feeding material The bottom side of the mouth is provided with a drying device, which can perform the first step of dry dewatering of the garbage entering from the feeding port, and the lower side of the drying device is provided with a gate device, the gate device is used for Preventing the falling of the garbage in the drying device, and simultaneously cutting off the power of the drying device when the shutter device is opened, the power device is connected to the right side of the shutter device, and the lower side of the gate device is connected with the blanking device a cone having a transport chamber connected to a lower side of the feed cone, a preheating tube disposed outside the transport chamber, a transport shaft disposed in the transport chamber, and a right end of the transport shaft is dynamically connected to the power device, A spiral plate is fixed on the transport shaft, and a belt cavity is connected to the lower end of the transport cavity, and two belt rotating shafts are symmetrically arranged in the belt cavity, and the front and rear ends of the belt rotating shaft are rotatably connected to the front and rear of the belt cavity. end The rear end of the belt rotating shaft is electrically connected to the power device, and the belt rotating shaft is fixed with a belt rotating wheel, and the belt rotating wheels on both sides are connected by a belt, and the belt rotating wheels are arranged on both sides. There are ten heating pipes evenly disposed on the lower side of the belt cavity, and the ventilation device is configured to send outside air into the belt cavity, and take away the moisture in the garbage in the belt cavity. An exhaust duct is disposed in an upper end surface of the belt cavity, a rear end of the exhaust duct is connected to the outside, a discharge port is arranged on a left side of the ventilation device, and an upper end of the discharge port is connected to the belt cavity, The left end of the belt cavity is connected to the outside.

Preferably, the preheating tube can preheat the garbage when the garbage passes through the transport chamber, so that there is already a certain temperature when entering the belt cavity, which helps to accelerate the evaporation of water in the belt cavity.

Wherein the spin-drying device comprises a spin-drying cavity on the lower side of the feed opening, the left end of the spin-drying cavity is connected to the outside through a drain pipe, and the spin-drying cavity is rotated in a spin-drying cavity, the weir The drying drum is uniformly provided with a drainage hole, and the drying drum is uniformly provided with four spacing nets, the outer side of the drying barrel is fixed with a toothed ring, and the right side of the drying chamber is provided with a drying gear chamber. The right end of the ring gear is located in the spin-drying gear cavity and is meshed with a spin-drying gear, the spin-drying gear center is provided with a spin-drying belt from the shaft, and the spin-drying belt is provided with a belt-receiving wheel from the shaft, a belt slave wheel is located at a lower side of the spin-drying gear, a right side of the spin-drying gear chamber is provided with a drying belt cavity, and a shaft of the drying belt is provided with a main belt of a drying belt, and a center of the main wheel of the drying belt A belt main shaft is fixed, and a lower end of the belt main shaft is dynamically connected to the shutter device, and the main belt of the spin-drying belt and the belt are mechanically connected by a drying belt.

Preferably, the spacer net is used to drive the garbage inside the drying drum to follow the rotation when the drying drum rotates, thereby ensuring the drying effect.

Wherein, the gate device comprises a gate sliding cavity on a lower side of the drying chamber, a sliding gate is arranged in the sliding cavity of the sliding gate, a cylinder is arranged on a rear side of the sliding cavity of the sliding device, and a cylinder is connected to the left end of the cylinder. a connecting rod, a left end of the cylinder connecting rod extends into the sliding chamber of the gate and is fixed to the rear end surface of the gate, a sliding chamber is disposed on the right side of the sliding chamber of the sliding chamber, and the sliding sliding chamber is provided with sliding sliding a separation spring is fixedly connected to the right end of the separation slider, and a left side of the separation slider abuts a separation push rod, and a left end of the separation push rod extends into the sliding chamber of the gate and is fixed on the right end surface of the gate a separating gear chamber is disposed at a right end of the separating sliding chamber, a separating shaft is disposed in the separating gear chamber, a left end of the separating shaft is rotatably connected to a right end surface of the separating slider, and the separating shaft is located in the separating gear chamber a split bevel gear is fixed on the inner portion, a lower end of the belt main shaft extends into the split gear cavity and a bevel gear is fixed, and the left side of the bevel gear is meshed with the split bevel gear, and the separation The right side of the shaft is provided with a linkage shaft, and the linkage shaft The release shaft spline-engaged with the right end of the interlocking shaft is connected to the power means power.

Preferably, the separating push rod abuts but is not fixed to the separating slider, and the separating slider is under the action of the separating spring when the shutter drives the separating push rod to the left. Moving in the separation sliding chamber to the left, and stopping when the left end surface of the separating slider abuts against the left end wall of the separating sliding chamber, and when the sliding gate drives the separating push rod to the right, the right end of the separating push rod Extending into the separation slide cavity and abutting against the left end wall surface of the separation slider, and pushing the separation slider to move to the right.

Wherein the power device includes a first gear cavity located on a right side of the split gear cavity, a right end of the link shaft extends into the first gear cavity and a first bevel gear is fixed, the first bevel gear is behind a second bevel gear is engaged on the side, a motor shaft is fixed in a center of the second bevel gear, a motor gear cavity is arranged on a rear side of the first gear cavity, and a power motor is fixed in a rear end wall of the motor gear cavity. The motor shaft rear end is dynamically connected to the power motor, the motor shaft is located on the inner portion of the motor gear chamber, and the motor bevel gear is fixed, and the lower side of the motor bevel gear is meshed with a third bevel gear, a third shaft gear is fixed on a lower side of the third bevel gear, and a second gear chamber is disposed on a lower side of the motor gear chamber. The vertical shaft extends through the second gear chamber and is fixed with a fourth bevel gear. a fifth bevel gear is engaged on the side, a transport power shaft is fixed in a center of the fifth bevel gear, a transport gear cavity is disposed on a front side of the fourth bevel gear, and a front end of the transport power shaft extends into the transport gear cavity and Fixing a sixth bevel gear, the sixth bevel gear a transport bevel gear, a left end surface of the transport bevel gear is fixedly connected to the right end of the transport shaft, a lower side of the second gear chamber is provided with a third gear chamber, and the vertical shaft penetrates the third gear chamber and is fixed a seventh bevel gear, a front end of the seventh bevel gear is meshed with a bevel gear, and a rear end of the belt rotating shaft extends into the third gear cavity, and the bevel gear is fixed to the rear end of the belt rotating shaft a fourth gear chamber is disposed on a lower side of the third gear chamber, a lower end of the vertical shaft extends into the fourth gear chamber and an eighth bevel gear is fixed, and a front end of the eighth bevel gear is meshed with a ninth bevel gear The ninth bevel gear center is fixed with a fan power shaft, and the fan power shaft front end is dynamically connected to the ventilation device.

Wherein, the ventilation device comprises an air inlet passage located in a lower end wall of the belt cavity, the air inlet passage is located at a right side of the discharge opening, a beam is fixed in the air inlet passage, and the beam is front and rear The end is fixed to the inner wall of the air inlet passage, and a fan gear chamber is disposed in the beam, a front end of the fan power shaft extends into the fan gear chamber and a tenth bevel gear is fixed, and the tenth bevel gear is left The side is meshed with a fan bevel gear, and the fan bevel gear center is fixed with a fan rotating shaft, and the left end of the fan rotating shaft extends into the air inlet passage and is fixed with a fan.

The invention has the beneficial effects that the invention adopts a multi-stage drying method, firstly drying the garbage to remove a large amount of water, and then evaporating the remaining water by heating, and taking away the moisture through the air flow to achieve the purpose of drying, the device The overall footprint is small, no need for a large number of people to participate, the drying speed is fast, the drying effect is good, the work efficiency is improved, and it is not affected by the rainy weather, and can work at any time.

### BRIEF DESCRIPTION OF THE DRAWINGS

For ease of description, the present invention is described in detail by the following specific embodiment and the accompanying drawings.

FIG. 1 is a schematic view showing the overall structure of a waste water filtering garbage drying device of the present invention;

FIG. 2 is an enlarged schematic view of “A” of FIG. 1;

FIG. 3 is a schematic enlarged view of “B” of FIG. 1;

FIG. 4 is a schematic structural view of the “C-C” direction of FIG. 1;

FIG. 5 is a schematic structural view of the “D-D” direction of FIG. 1;

FIG. 6 is a schematic structural view of the “E-E” direction of FIG. 1;

FIG. 7 is a schematic enlarged view showing the structure of “F” of FIG. 6.

### DETAILED DESCRIPTION OF THE INVENTION

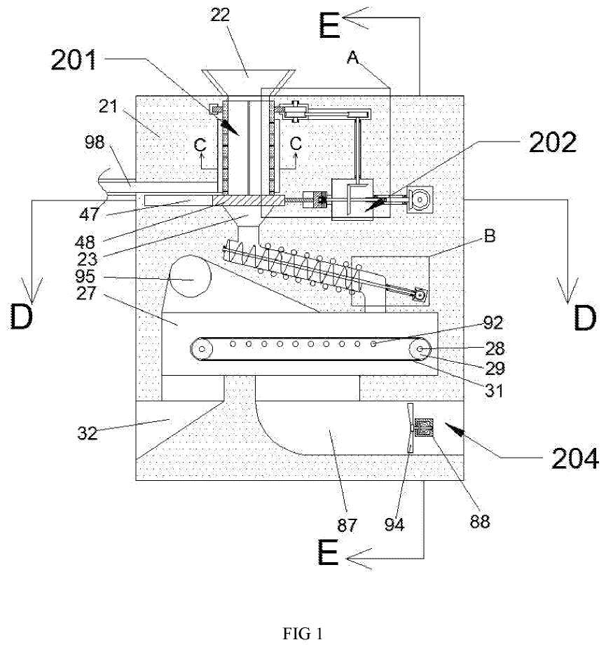

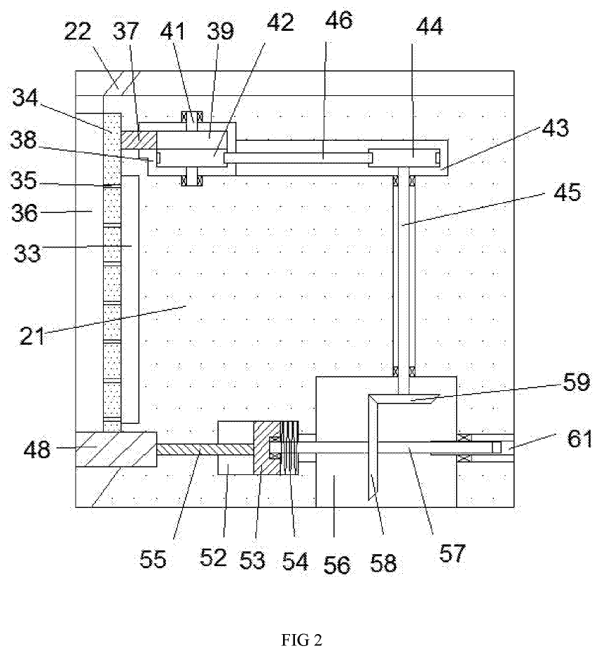

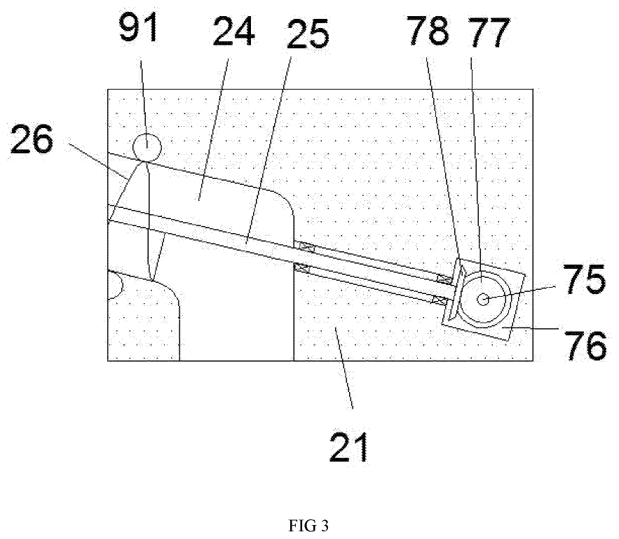

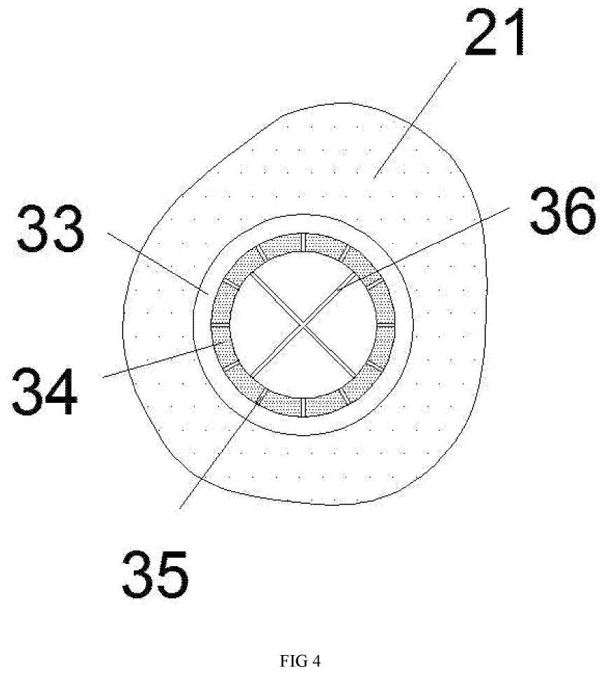

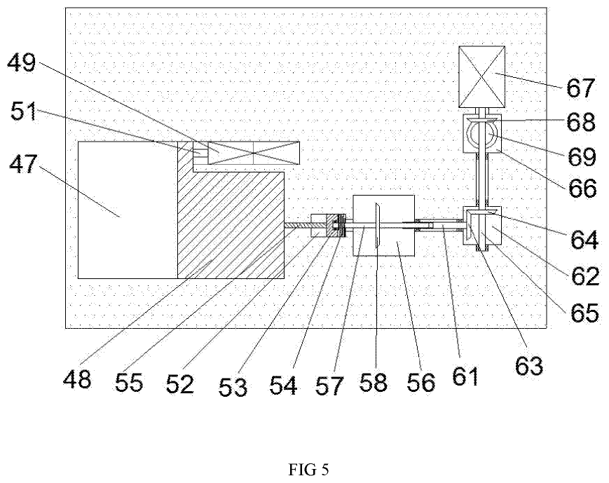

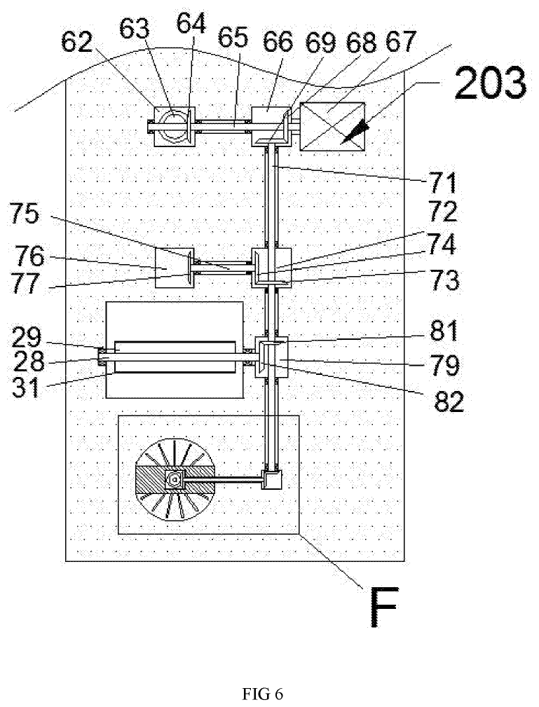

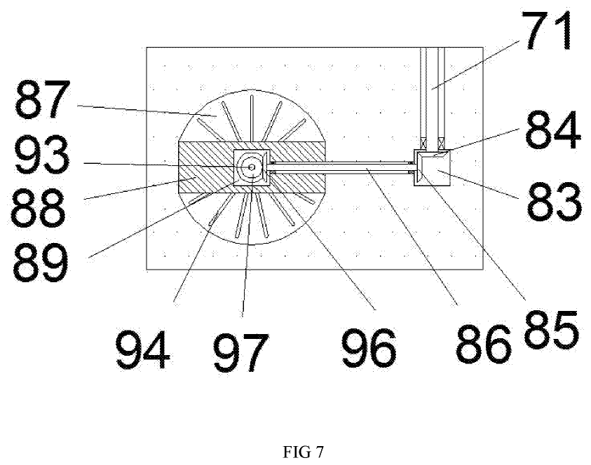

The present invention will now be described in detail with reference to FIGS. 1 to 7. For the convenience of description, the orientations described below are defined as follows: the up, down, left, and right front and rear directions described below are identical to the up, down, left, and right front and rear directions of the projection relationship of FIG. 1 itself.

The invention relates to a waste water filtering garbage drying device, which is mainly used in the process of garbage drying. The present invention will be further described below in conjunction with the drawings of the present invention:

A waste water filtering garbage drying device according to the present invention includes a main body 21, a feeding port 22 is fixed on an upper end surface of the main body 21, and a drying device 201 is disposed on a lower side of the feeding port 22, The drying device 201 can perform the first step of dry dewatering of the garbage entering from the feeding port 22, and the lower side of the drying device 201 is provided with a gate device 202 for preventing the drying device The garbage in the 201 is dropped, and the power of the drying device 201 is cut off when the shutter device 202 is opened. The power device 203 is connected to the right side of the shutter device 202, and the lower side of the shutter device 202 is connected to the blanking device. a cone 23, a lower side of the lowering cone 23 is connected with a transport chamber 24, a preheating tube 91 is arranged outside the transport chamber 24, a transport shaft 25 is arranged in the transport chamber 24, and a right end of the transport shaft 25 is connected. To the power unit 203, a spiral plate 26 is fixed on the transport shaft 25, and a belt chamber 27 is connected to the lower end of the transport chamber 24. The belt chamber 27 is provided with two belt shafts 28 which are bilaterally symmetrical. The front and rear ends of the belt rotating shaft 28 are rotatably connected to the belt cavity 27 In the two end walls, the rear end of the belt rotating shaft 28 is connected to the power unit 203 at the rear end, and the belt rotating shaft 28 is fixed with a belt runner 29, and the belt rotating wheels 29 on both sides are dynamically connected by the belt 31. Ten heating pipes 92 are disposed between the belt runners 29 on both sides, and a ventilation device 204 is disposed on the lower side of the belt cavity 27, and the ventilation device 204 is configured to send outside air into the belt cavity 27 The air in the garbage in the belt chamber 27 is taken away, and an air exhaust duct 95 is disposed in the upper end surface of the belt chamber 27, and the rear end of the air exhaust duct 95 is connected to the outside, and the left side of the ventilation device 204 is disposed. There is a discharge port 32, and the upper end of the discharge port 32 is connected to the belt cavity 27, and the left end of the belt cavity 27 is connected to the outside.

Beneficially, the preheating tube 91 can preheat the garbage when the garbage passes through the transport chamber 24, so that there is already a certain temperature when entering the belt chamber 27, which helps to speed up in the belt chamber 27. The water evaporates.

According to the embodiment, the drying device 201 is described in detail below. The drying device 201 includes a spin chamber 33 on the lower side of the feed port 22, and the left end of the spin chamber 33 is connected to the outside through the drain pipe 98. a drying drum 34 is disposed in the drying chamber 33. The drying drum 34 is uniformly provided with a drainage hole 35. The drying drum 34 is uniformly provided with four spacing nets 36. A tooth ring 37 is fixed on the outer side of the barrel 34, and a spin gear chamber 38 is disposed on the right side of the spin chamber 34. The right end of the ring gear 37 is located in the spin gear chamber 38 and meshes with the dry gear 39. The center of the dry gear 39 is fixed with a drying belt from the shaft 41, and the drying belt is provided with a belt slave wheel 42 from the shaft 41, and the belt slave wheel 42 is located at the lower side of the drying gear 39. A dry belt chamber 43 is disposed on the right side of the drying gear chamber 38, and a drying belt main wheel 44 is disposed in the drying belt chamber 43, and a belt main shaft 45 is fixed in the center of the main belt 44 of the drying belt, The lower end of the belt main shaft 45 is power-connected to the shutter device 202, and the spin-drying belt main wheel 44 and the belt-receiving wheel 42 are dynamically connected by a drying belt 46.

Advantageously, the spacer net 36 is used to drive the internal garbage following rotation of the drying drum 34 when the drying drum 34 rotates, thereby ensuring the drying effect.

According to the embodiment, the gate device 202 is described in detail below. The shutter device 202 includes a gate sliding chamber 47 located on the lower side of the spin chamber 33. The gate sliding chamber 47 is slidably provided with a gate 48, the gate A cylinder 49 is disposed on the rear side of the sliding chamber 47, and a cylinder connecting rod 51 is dynamically connected to the left end of the cylinder 49. The left end of the cylinder connecting rod 51 extends into the sliding chamber 47 of the cylinder and is fixed to the rear end surface of the gate 48. A separating slide chamber 52 is disposed on the right side of the sliding chamber 47. A sliding slider 53 is disposed in the separating sliding chamber 52. A separating spring 54 is fixed to the right end of the separating slider 53. The left end of the separating slider 53 a separation pusher 55 is abutted, a left end of the split push rod 55 extends into the shutter slide cavity 47 and is fixed on the right end surface of the shutter 48, and a split gear cavity 56 is disposed at a right end of the split slide cavity 52. A separation shaft 57 is disposed in the separation gear chamber 56. The left end of the separation shaft 57 is rotatably connected to the right end surface of the separation slider 53. The separation shaft 57 is located on the inner portion of the separation gear chamber 56 and is provided with a separation cone. a gear 58 having a lower end of the belt main shaft 45 extending into the split gear chamber 56 and having a dry cone a wheel 59, the left side of the bevel gear 59 is meshed with the separating bevel gear 58, and the right side of the separating shaft 57 is provided with a linkage shaft 61, and the linkage shaft 61 and the separating shaft 57 are spline-engaged. The right end of the linkage shaft 61 is dynamically connected to the power unit 203.

Advantageously, the separating push rod 55 abuts but is not fixed to the separating slider 53, and the separating spring 54 acts under the action of the separating spring 54 when the shutter 48 drives the separating push rod 55 to the left. The slider 53 moves to the left in the separation sliding chamber 52, and stops when the left end surface of the separation slider 53 abuts against the left end wall of the separation sliding chamber 52, when the shutter 48 drives the separation push rod 55 When moving to the right, the right end of the separating push rod 55 projects into the separating slide chamber 52 and abuts against the left end wall surface of the separating slider 53, and pushes the separating slider 53 to the right.

According to an embodiment, the power unit 203 is described in detail below, the power unit 203 includes a first gear chamber 62 located on the right side of the split gear chamber 56, and the right end of the link shaft 61 extends into the first gear chamber 62. And a first bevel gear 63 is fixed, a rear side of the first bevel gear 63 is meshed with a second bevel gear 64, and a center of the second bevel gear 64 is fixed with a motor shaft 65. A motor gear chamber 66 is disposed on the side, and a power motor 67 is fixed in a rear end wall of the motor gear chamber 66. The rear end of the motor shaft 65 is dynamically connected to the power motor 67, and the motor shaft 65 is located at the motor. A motor bevel gear 68 is fixed on a portion of the gear chamber 66. The lower side of the motor bevel gear 68 is meshed with a third bevel gear 69. The third bevel gear 69 has a vertical shaft 71 fixed therein. The motor gear chamber 66 a second gear chamber 72 is disposed on the lower side, the vertical shaft 71 extends through the second gear chamber 72 and is fixed with a fourth bevel gear 73. The front side of the fourth bevel gear 73 is meshed with a fifth bevel gear 74. The fifth bevel gear 74 is fixed with a transport power shaft 75 at the center, and the fourth bevel gear 73 is transported on the front side. a gear chamber 76, a front end of the transport power shaft 75 extends into the transport gear chamber 76 and is fixed with a sixth bevel gear 77. The sixth bevel gear 77 is meshed with a transport bevel gear 78, and the left end of the transport bevel gear 78 The surface is fixedly connected to the right end of the transport shaft 25, and the lower side of the second gear chamber 72 is provided with a third gear chamber 79. The vertical shaft 71 extends through the third gear chamber 79 and is fixed with a seventh bevel gear 81. The front end of the seventh bevel gear 81 is meshed with a bevel gear 82, and the rear end of the belt rotating shaft 28 extends into the third gear chamber 79. The bevel gear 82 is fixed to the belt rotating shaft 28. The fourth gear chamber 83 is disposed on the lower side of the third gear chamber 79. The lower end of the vertical shaft 71 extends into the fourth gear chamber 83 and is fixed with an eighth bevel gear 84. The eighth bevel gear 84 is 84. The front end is engaged with a ninth bevel gear 85. The ninth bevel gear 85 is fixed with a fan power shaft 86 at the center thereof, and the front end of the fan power shaft 86 is dynamically connected to the ventilation device 204.

According to an embodiment, the ventilation device 204 is described in detail below, the ventilation device 204 includes an air inlet passage 87 located in the lower end wall of the belt chamber 27, and the air inlet passage 87 is located at the right side of the discharge port 32. A beam 88 is fixed in the air inlet passage 87. The front and rear ends of the beam 88 are fixed to the inner wall of the air inlet passage 87. The beam 88 is provided with a fan gear chamber 89. The front end of the fan power shaft 86 Extending into the fan gear chamber 89 and fixing a tenth bevel gear 96, the left side of the tenth bevel gear 96 is meshed with a fan bevel gear 97, and a fan rotating shaft 93 is fixed at a center of the fan bevel gear 97. The left end of the fan shaft 93 extends into the air inlet passage 87 and is fixed with a fan 94.

The following describes the steps of using the wastewater filtering garbage drying device in the following with reference to FIG. 1 to FIG. 7:

In the initial state, the right end surface of the shutter 48 abuts against the right end wall of the shutter sliding chamber 47, and the separating push rod 55 pushes the separating slider 53, so that the right end surface of the separating slider 53 abuts against the right end wall of the separating sliding chamber 52, thereby making the separating bevel gear 58 meshes with the bevel gear 59, and the power motor 67 does not operate.

At the beginning of the work, the garbage is turned into the drying drum 34 from the feeding port 22, and the power motor 67 is started. The power motor 67 drives the motor shaft 65 to rotate, and the meshing of the second bevel gear 64 and the first bevel gear 63 causes the interlocking shaft. 61 rotates, and through the meshing of the bevel gear 58 and the bevel gear 56, the belt main shaft 45 is rotated, and the inner belt 44 and the belt 42 are driven by the drying belt 46 to drive the drying belt. The shaft 41 rotates, and the rotation of the drying drum 34 is driven by the engagement of the drying gear 39 and the ring gear 37, so that the garbage in the drying drum 34 is dried and dehydrated, and the drained water enters the drying chamber 33 via the drainage hole 35 and is The drain pipe 98 flows to the outside. When the rubbing water in the drying drum 34 is completed, the cylinder 49 drives the cylinder connecting rod 51 to move the gate 48 to the left, thereby causing the separating push rod 55 to move to the left, and the separating slider 53 acts on the separating spring 54. Moving downward to the left, the separating bevel gear 58 is separated from the bevel gear 56, so that the drying drum 34 loses power and stops rotating. When the left end of the shutter 48 abuts to the left end wall of the sliding chamber 47, the lower end of the drying drum 34 communicates with Cutting cone 23, garbage in the drying bucket 34 Into the feed cone 23, then cylinder 49 to drive the shutter cylinder 48 such that right link 51, drying tub 34 and the lower feed cone 23 spaced to be re-poured into the feed port 22 of the next batch of rubbish;

When the power motor 67 is started, the preheating tube 91 and the heating tube 92 start to work, and the vertical shaft 71 is rotated by the meshing of the bevel gear 68 and the third bevel gear 69, and then passes through the fifth bevel gear 74 and the fourth bevel gear 73. The meshing drives the transport power shaft 75 to rotate, and the sixth bevel gear 77 meshes with the transport bevel gear 78 to drive the transport shaft 25 to rotate. The garbage falling into the lower cone 23 is driven by the spiral plate 26 via the transport chamber 24. Downwardly entering the belt chamber 27, the preheating tube 91 preheats the garbage in the transport chamber 24, and the seventh bevel gear 81 meshes with the bevel gear 82 to drive the belt rotating shaft 28 to rotate, thereby causing the belt 31 to move. When the garbage enters the belt cavity 27 through the transport chamber 24, it falls on the upper end surface of the belt 31, and moves to the left along with the belt 31, while the heating pipe 92 further dries the garbage, passes through the eighth bevel gear 84 and the fourth gear chamber 83. The meshing drives the fan power shaft 86 to rotate, and the meshing of the tenth bevel gear 96 and the fan bevel gear 97 causes the fan 94 to rotate, and the outside air is sucked into the belt cavity 27 via the air inlet passage 87 to carry the garbage on the belt 31. Hair water vapor, is discharged by the exhaust pipe 95, the dried refuse falling upon reaching the left end of the belt 31 down to the discharge port 32 unitary.

The invention has the beneficial effects that the invention adopts a multi-stage drying method, firstly drying the garbage to remove a large amount of water, and then evaporating the remaining water by heating, and taking away the moisture through the air flow to achieve the purpose of drying, the device The overall footprint is small, no need for a large number of people to participate, the drying speed is fast, the drying effect is good, the work efficiency is improved, and it is not affected by the rainy weather, and can work at any time.

In the above manner, those skilled in the art can make various changes depending on the mode of operation within the scope of the present invention.

1. A waste water filtering garbage drying apparatus comprising a main body; a feeding port is fixed on the upper end surface of the main body, and a drying device is arranged on the lower side of the feeding port, and the drying device can perform the first step of drying and dehydrating the garbage entering from the feeding port. a gate device is disposed on a lower side of the drying device, the gate device is configured to prevent the garbage from falling in the drying device, and the power of the drying device is cut off when the shutter device is opened, the gate device is right The side power is connected with a power device, the lower side of the shutter device is connected with a blanking cone, the lower side of the lowering cone is connected with a transport cavity, and the outer side of the transport cavity is provided with a preheating tube, and the transport chamber is provided with transportation a rotating shaft, the right end of the transport shaft is dynamically connected to the power device, and a spiral plate is fixed on the transport shaft; a belt cavity is connected to the lower end of the transport chamber, and two belt rotating shafts are symmetrically arranged in the belt cavity, and the front and rear ends of the belt rotating shaft are rotatably connected to the front and rear end walls of the belt cavity, and the belt is on the right side. The rear end of the rotating shaft is dynamically connected to the power device, and a belt rotating wheel is fixed on the belt rotating shaft, and the belt rotating wheels are connected by belts on both sides, and ten heating devices are arranged between the belt rotating wheels on both sides. a ventilation device is disposed on the lower side of the belt cavity, and the ventilation device is configured to send outside air into the belt cavity, and take away moisture in the garbage in the belt cavity, and the upper end surface of the belt cavity is provided There is an exhaust duct, the rear end of the exhaust duct is connected to the outside, and a discharge port is arranged on the left side of the ventilation device, and an upper end of the discharge port is connected to the belt cavity, and a left end of the belt cavity is connected to the outside.

2. The waste water filtering garbage drying apparatus according to claim 1, wherein the preheating tube preheats the garbage when the garbage passes through the transport chamber, so that there is already a certain amount when entering the belt cavity. The temperature helps to accelerate the evaporation of moisture within the belt cavity.

3. The waste water filtering garbage drying apparatus according to claim 1, wherein said drying device comprises a spin drying chamber located on a lower side of said feed port the left end of the drying chamber is connected to the outside through a drain pipe, and the drying chamber is provided with a drying drum, and the drying drum is uniformly provided with a drainage hole, and the drying barrel is uniformly provided with four intervals. a mesh ring, a tooth ring is fixed on an outer side of the dry bucket, a spin gear gear is disposed on a right side of the spin cavity, and a right end of the ring gear is located in the spin gear cavity and meshes with a dry gear, The spin-drying gear center is provided with a spin-drying belt slave shaft, the spin-drying belt is provided with a belt slave wheel from the shaft, the belt slave wheel is located at the lower side of the spin-drying gear, and the right side of the spin-drying gear chamber is provided There is a drying belt cavity, a drying belt main wheel is disposed in the drying belt cavity, a belt main shaft is fixed in a center of the main shaft of the drying belt, and a lower end of the belt main shaft is dynamically connected to the gate device, The main belt of the drying belt and the belt are mechanically connected from the wheel through a drying belt.

4. The waste water filtering garbage drying apparatus according to claim 3, wherein the spacer net is used to drive the internal garbage of the drying drum to follow the rotation when the drying drum rotates to ensure the drying effect.

5. The waste water filtering garbage drying apparatus according to claim 1, wherein said shutter device comprises a gate sliding chamber located on a lower side of said spin chamber; a gate is slidably disposed in the sliding chamber of the gate, a cylinder is disposed on a rear side of the sliding chamber of the gate, and a cylinder connecting rod is dynamically connected to a left end of the cylinder, and a left end of the cylinder connecting rod extends into the sliding chamber of the gate and is fixed on the sliding chamber a rear sliding end of the gate, a sliding sliding chamber is disposed on a right side of the sliding chamber, a separating slider is disposed in the separating sliding chamber, and a separating spring is fixedly connected to the right end of the separating slider, and the left end of the separating slider is a separating push rod is disposed, the left end of the separating push rod extends into the sliding chamber of the gate and is fixed on the right end surface of the sliding gate, and a separating gear chamber is disposed at a right end of the separating sliding chamber, and the separating gear chamber is provided a separating shaft, a left end of the separating shaft is rotatably connected to the right end surface of the separating block, and a separating bevel gear is disposed on the inner portion of the separating gear cavity, and a lower end of the belt main shaft extends into the separating end a gear bore and a bevel gear, the left side of the bevel gear is meshed with the split bevel gear, the right side of the split shaft is provided with a linkage shaft, and the linkage shaft and the separation shaft are splined Engaged, the right end of the linkage shaft is electrically connected to the powerplant.

6. The waste water filtering garbage drying apparatus according to claim 5, wherein the separating push rod abuts but is not fixed to the separating slider, and when the shutter drives the separating push rod to the left The separating slider moves to the left in the separating sliding chamber under the action of the separating spring, and stops when the left end surface of the separating slider abuts against the left end wall of the separating sliding chamber, when the gate When the separation push rod is moved to the right, the right end of the separation push rod extends into the separation sliding chamber and abuts against the left end wall surface of the separation slider, and pushes the separation slider to the right.

7. The waste water filtering garbage drying apparatus according to claim 1, wherein said power unit comprises a first gear chamber located on a right side of said separation gear chamber; a right end of the linkage shaft extends into the first gear cavity and is fixed with a first bevel gear, a rear side of the first bevel gear is meshed with a second bevel gear, and a center of the second bevel gear is fixed with a motor shaft. a motor gear chamber is disposed on a rear side of the first gear chamber, a power motor is fixed in a rear end wall of the motor gear chamber, and a rear end of the motor shaft is dynamically connected to the power motor, and the motor shaft is located in the motor shaft A motor bevel gear is fixed on a portion of the motor gear cavity, and a lower side of the motor bevel gear is meshed with a third bevel gear, and a center of the third bevel gear is fixed with a vertical shaft.

8. The waste water filtering garbage drying apparatus according to claim 1, wherein a lower side of the motor gear chamber is provided with a second gear chamber, and the vertical shaft extends through the second gear chamber and is fixed fourth. a bevel gear, a front side of the fourth bevel gear is meshed with a fifth bevel gear, a center of the fifth bevel gear is fixed with a transport power shaft, and a front side of the fourth bevel gear is provided with a transport gear cavity, and the transport power is a front end of the shaft extends into the transport gear cavity and is fixed with a sixth bevel gear, the sixth bevel gear meshes with a transport bevel gear, and a left end surface of the transport bevel gear is fixedly connected to a right end of the transport shaft, and the second a third gear cavity is disposed on a lower side of the gear cavity, the vertical shaft penetrates the third gear cavity and a seventh bevel gear is fixed, the front end of the seventh bevel gear meshes with a bevel gear, and the right side of the belt rotates the shaft The end of the vertical gear is fixed in the third gear chamber, the belt bevel gear is fixed to the rear end of the belt rotating shaft, the lower side of the third gear chamber is provided with a fourth gear chamber, and the lower end of the vertical shaft extends into the first a four-gear cavity and an eighth bevel gear, the eighth bevel gear The front end is engaged with a ninth bevel gear, and a center of the ninth bevel gear is fixed with a fan power shaft, and a front end of the fan power shaft is dynamically connected to the ventilation device.

9. The waste water filtering garbage drying apparatus according to claim 1, wherein said ventilation means comprises an air inlet passage located in a lower end wall of said belt cavity; the air inlet channel is located at a right side of the discharge port, and a beam is fixed in the air inlet channel, and the front and rear ends of the beam are fixedly connected to the inner wall of the air inlet channel, and the fan gear cavity is disposed in the beam a front end of the fan power shaft extends into the fan gear cavity and a tenth bevel gear is fixed, a fan bevel gear is meshed on a left side of the tenth bevel gear, and a fan rotating shaft is fixed in a center of the fan bevel gear. The left end of the fan shaft extends into the air inlet passage and has a fan
